(19) United States
(12) Patent Application Publication
(10) Pub. No.: US 2026/0247259 A1
(43) Pub. Date: Aug. 20, 2026

(54) METHODS, ARCHITECTURES, APPARATUSES AND SYSTEMS FOR SENSING OPERATION RESTRICTIONS AND ENFORCEMENT

(71) Applicant: InterDigital Patent Holdings, Inc., Wilmington, DE (US)

(72) Inventors: Zhibi Wang, Woodridge, IL (US); Jung Je Son, Warrington, PA (US); Magurawalage Chathura Madhusanka Sarathchandra, London (GB); Anuj Sethi, Ottawa (CA); Taimoor Abbas, Sainte-Julie (CA)

(21) Appl. No.: 19/058,846

(22) Filed: Feb. 20, 2025

(51) Int. Cl. H04W 48/02; H04W 8/22; H04W 24/08

(52) U.S. Cl. CPC H04W 48/02; H04W 8/22; H04W 24/08

(57) ABSTRACT

A method, performed by a wireless transmit/receive unit (WTRU), includes transmitting, to a wireless network, first information indicating WTRU sensing capabilities and indicating consent information associated with sensing operations. The method includes receiving, from the wireless network, second information indicating a sensing restriction policy and an initiation instruction. The sensing restriction policy is generated by a core network of the wireless network based on any one or more of restriction areas, a sensing entity allow list, a sensing entity block list, one or more regulations, one or more privacy laws, or user consent. The method includes configuring the WTRU for the sensing operations based on the sensing restriction policy. The method includes performing sensing operations based on the initiation instruction and on the sensing restriction policy to generate sensing measurement information. The method includes transmitting, to the wireless network, the sensing measurement information based on the sensing restriction policy.

### TECHNICAL FIELD

The present disclosure is generally directed to the fields of communications, software and coding, including, for example, to methods, architectures, apparatuses, systems related to sensing operation restrictions and enforcement.

### BACKGROUND

In some implementations, a device (e.g., a user equipment or a wireless transmit/receive unit) performing a sensing operation may not be enabled to discover, select, activate, and/or reactivate sensing entities with restrictions based on dynamic conditions associated with the sensing operation.

### SUMMARY

In accordance with certain embodiments of the present disclosure, methods, and systems are provided for operating a WTRU to enforce restrictions on a sensing operation. A WTRU may be configured to communicate with a wireless network and perform sensing operations. A method includes transmitting, to a wireless network, first information indicating sensing capabilities of the WTRU and indicating consent information associated with sensing operations. The method further includes receiving, from the wireless network, second information indicating a sensing restriction policy and an initiation instruction, where the sensing restriction policy is generated by a core network of the wireless network based on any one or more of restriction areas, a sensing entity allow list, a sensing entity block list, one or more regulations, or one or more privacy laws. The method additionally includes configuring the WTRU for the sensing operations based on the sensing restriction policy. The method moreover includes performing the sensing operations based on the initiation instruction and on the sensing restriction policy to generate sensing measurement information. The method also includes transmitting, to the wireless network, the sensing measurement information based on the sensing restriction policy.

In certain embodiments, the first information indicates a plurality of sensing entities and a sensing role for each of the plurality of sensing entities, where the sensing role includes any one of monitoring entity, sending entity, or target entity. In certain embodiments, transmitting the first information includes any one of: a WTRU registration procedure; network function (NF), application function (AF), or network exposure function (NEF) signaling; control plane signaling; periodic-based reporting; or event-based reporting.

In certain embodiments, core network generates the sensing restriction policy further based on any of the following parameters: proximity of the sensing operations; a location of interest; a network operator identity; a sensing data consumer; a time frame; an accuracy; sensing entities and corresponding roles; power requirements; a mobile network operator; a WTRU role; or a public or private designation. In certain embodiments, the sensing restriction policy includes any of the following restrictions: sensing location restrictions; sensing collection time restrictions; service network restrictions; sensing information consumer restrictions; or scope restrictions. In certain embodiments, the sensing restriction policy includes any of the following conditions: allowed actions; disallowed actions; accuracy reduction; image blurring; text removal; sensing data consumer restrictions; or privacy information anonymization. In certain embodiments, the sensing restriction policy indicates that the WTRU must request authorization from the core network before performing or transmitting each of the sensing operations.

In certain embodiments, the initiation instruction includes a timer value indicating when to start performing the sensing operations. In certain embodiments, the sensing measurement information includes an indication of whether the sensing restriction policy was successfully implemented. In certain embodiments, performing the sensing operations based on the sensing restriction policy includes enforcing the sensing restriction policy during at least one of: sensing entity discovery, sensing data collection, sensing data processing, or sensing result release.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a reference model of an example wireless network with which a WTRU communicates, in accordance with certain embodiments;

FIG. 3 is a diagram depicting an example of a pedestrian and/or animal intrusion detection, in accordance with certain embodiments;

FIG. 4 is a diagram depicting an example of intruder detection in surroundings of a smart home, in accordance with certain embodiments;

FIG. 5 is a diagram depicting an example of a multiple access channel with bistatic base station sensing, in accordance with certain embodiments;

FIG. 6 is a flowchart of an illustrative approach for sensing operation restrictions and enforcement, in accordance with certain embodiments; and

FIG. 7 is a flowchart of an illustrative method performed by a WTRU for sensing operation restrictions and enforcement, in accordance with certain embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

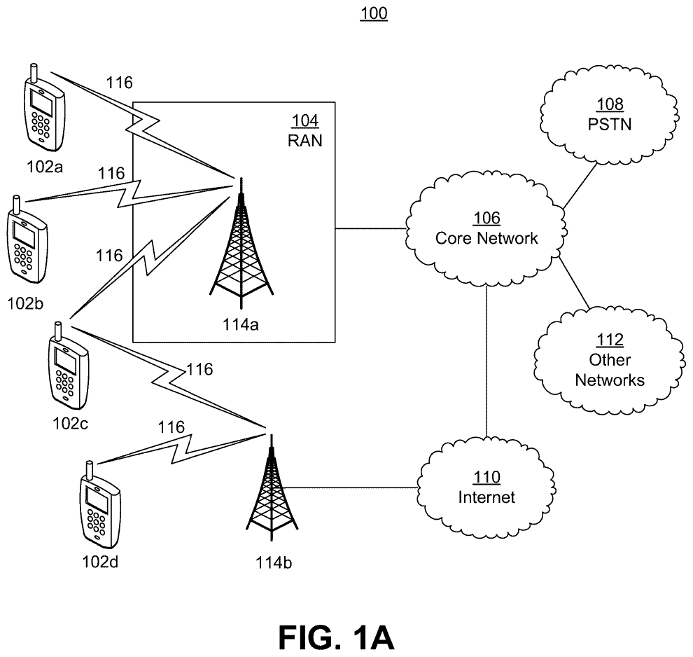

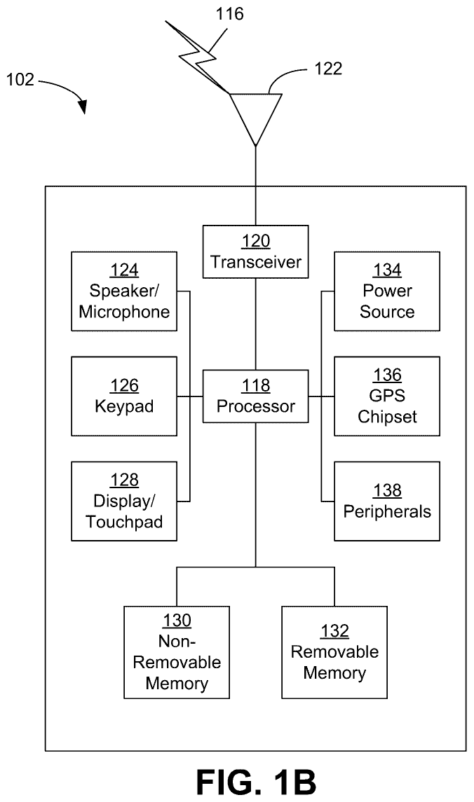

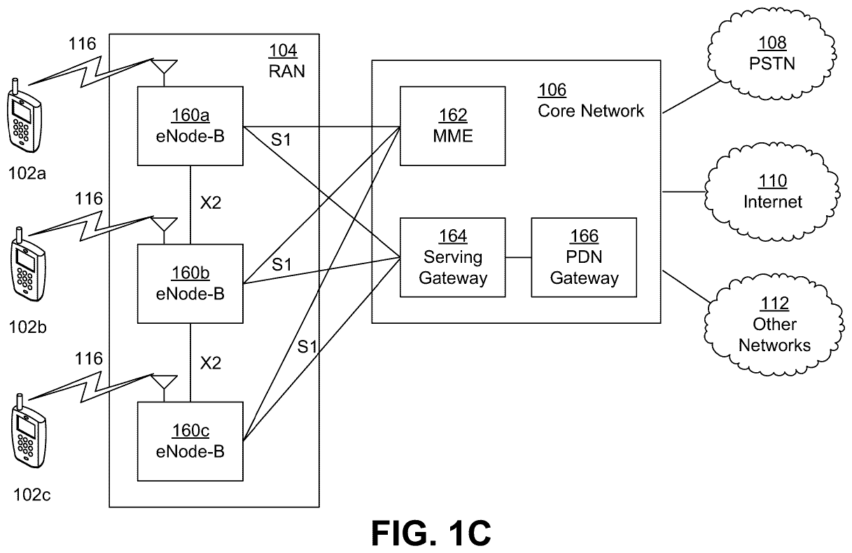

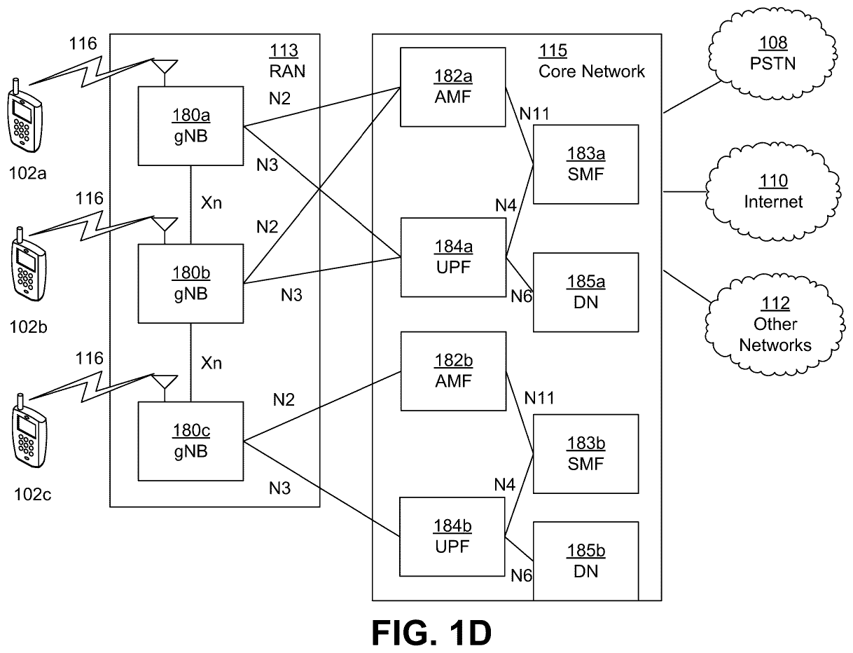

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

It will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

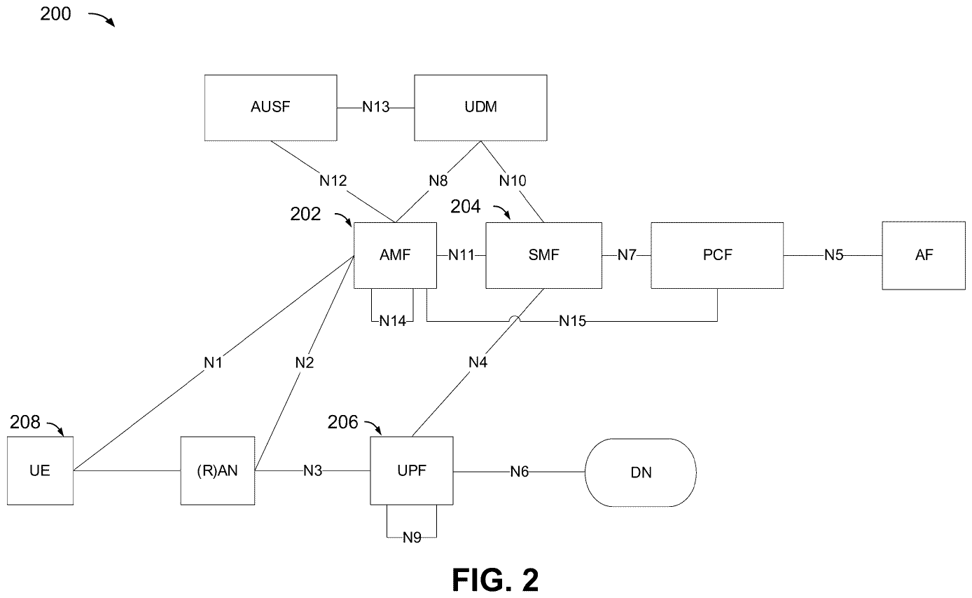

In certain embodiments of the present disclosure, including those described below at least in connection with FIGS. 2-7, the devices, systems, architectures, communication links, apparatuses, and other elements depicted in FIGS. 1A-1D may be used in connection with sensing operation restrictions and enforcement.

To enable integrated sensing, network functions collectively referred to as sensing NFs are defined. For example, a sensing NF may be an integrated sensing assistance NF (ISANF) or a sensing operation management function (SOMF). An ISANF and SOMF are logical entities and may be collocated with another entity. In certain embodiments, an ISANF may be collocated at a network exposure function (NEF). In certain representative embodiments, an ISANF and an SOMF are both collocated at an NEF. In certain representative embodiments, a SOMF may be collocated with an AMF or may be collocated with an RAN.

In certain embodiments, an ISANF oversees interaction with an application function (AF) for sensing service. An ISANF may interpret a service request from an AF and may derive a corresponding requested sensing mechanism. Based on the sensing mechanism, an ISANF forwards the request to the relevant NFs within a 5GC which serve a region of interest or requested entities such as WTRUs. When an AF is a 3rd party application which is not a trusted entity of a 5GS, an AF and an ISANF may communicate via an NEF.

In certain embodiments, an SOMF may handle coordination of sensing operations among base stations and WTRUs. Based on information received from an AMF (e.g., a requested sensing region, a list of base stations and WTRUs, or requested sensing mechanism with a certain QoS requirement), an SOMF may derive coordination information for a sensing operation. For example, an SOMF may decide the particular roles for certain entities such as whether an entity acts as a sender of sensing signal, receiver of sensing signal, a collector of sensing measurement data, or a calculator to calculate a sensing result. An SOMF may determine a sensing period or the waveform of a sensing signal. An SOMF may query base stations or sender resource assignments for a sending sensing signal during the sensing period.

It will be understood that a sensing task is a process where one or more sensors (e.g., RF, video, audio sensors) are used for generating data about an environment (e.g., a target object, a user). Generated data may be consumed or stored by a WTRU, 5GS, an application, or any other network entity. The 5G system may provide a way to manage the sensors or sensing entities, process sensing data, or communicate sensing data/results from the sensing entities to respective destination/data consumers (e.g., a WTRU, NF, AF, or RAN).

FIG. 2 is a reference model of an example wireless network with which a WTRU communicates, in accordance with certain embodiments.

In accordance with certain embodiments of this disclosure, a reference model of a 5G network, or other suitable network, is shown in FIG. 2 and described as follows. FIG. 2 illustrates an example of a reference model of a network architecture (e.g., a 5G or NextGen network). In certain representative embodiments, AMF 202 (e.g., which may be the same as AMF 182a or 182b) includes the functionalities of registration management, connection management, reachability management, and mobility management. In certain representative embodiments, SMF 204 (e.g., which may be the same as SMF 183a or 183b) includes the functionalities of session management (e.g., session establishment, modification, and release), WTRU IP address allocation, selection, and control of UPFs. In certain representative embodiments, the UPF 206 (e.g., which may be the same as UPF 184a or 184b) includes the functionalities of packet routing, packet forwarding, packet inspection, and traffic usage reporting.

Integrated sensing may include different potential requirements for specific use cases. Integrated sensing may enhance a 5G system such that the 5G system may better provide sensing services addressing different target verticals/applications (e.g., autonomous/assisted driving, vehicle to everything (V2X), unmanned aerial vehicles (UAVs), 3D mapping, smart city, smart home, factories, healthcare, or maritime sector applications).

In integrated sensing applications, there may be a process of collecting sensing measurement data. The sensing measurement data, for example, may be data collected about radio/wireless signals impacted (e.g., reflected, refracted, diffracted) by an object or by an environment of interest for sensing purposes. An example of generating sensing measurement data may be deriving sensing results from processing sensing measurement data. There may also be an area defined for sensing, e.g., a sensing service area (SSA) location, which may be an area or location (with or without at least one obstacle) in which the SSA can provide sensing service with target quality. Still further, for example, non-3GPP (N3GPP) entities are considered; sensing measurement data related to N3GPP entities may be considered as transparent to 5GS, such that the corresponding data may be communicated using a standard protocol to an interface defined by the 5GS. One use case for integrated sensing is object detection for a pedestrian/animal intrusion detection on a highway.

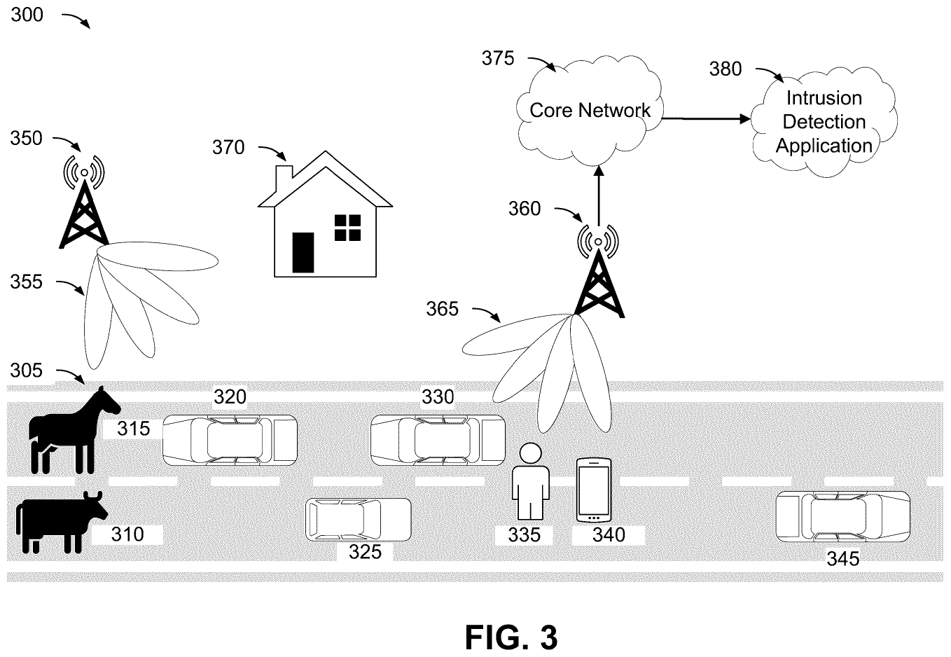

FIG. 3 is a diagram depicting an example of a pedestrian and/or animal intrusion detection, in accordance with certain embodiments.

As shown in FIG. 3, for example, in an outdoor environment 300, pedestrian and/or animal intrusion detection is provided. Environment 300 includes highway 305 and residential property 370 adjacent highway 305. Base station 350 (e.g., which may be the same as base station 114a or 114b) at a first location and base station 360 at a second location emit beams 355 and 365, respectively. Beams 355 and 365 interact with highway 305 and objects 310-345 on highway 305 such as a first animal (e.g., cow) 310, a second animal (e.g., horse) 315, first vehicle 320 traveling in a first direction (right-to-left on the page), second vehicle 325 traveling in a second direction (left-to-right) opposite the first direction, third vehicle 330 traveling in the first direction, pedestrian 335 traveling in the first direction, pedestrian 335 carrying WTRU 340 (e.g., which may be the same as WTRU 102a, 102b, 102c, or 102d), and fourth vehicle 345 traveling in the second direction. Information regarding highway 305, property 370, and objects 310-345 is transmitted by base station 360 (e.g., which may be the same as base station 114a or 114b)) to core network 375 (e.g., which may be the same as CN 106 or 115). Core network 375 transmits the information to intrusion detection application 380. Intrusion detection application 380 is configured to sense, identify, and/or track the objects 310-345, for example, with respect to base stations 350, 360 and/or one or more fixed points along highway 305 and/or property 370. Intrusion detection application 380 may be configured to differentiate between different types of vehicles (e.g., compact vehicle 325 versus large vehicle 345) or different types of objects (e.g., horse 315 versus human 335) and corresponding locations, directions of movement, velocities, or the like.

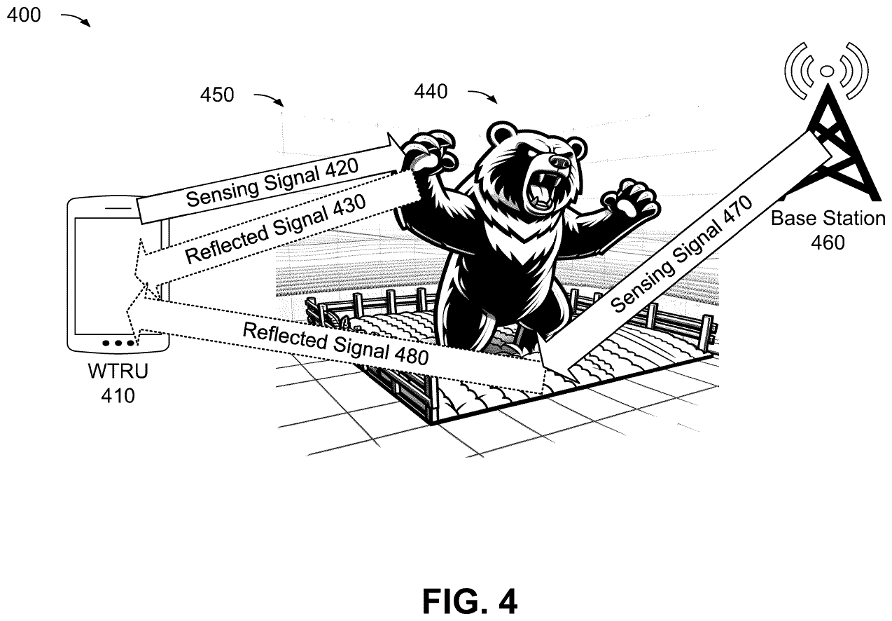

FIG. 4 is a diagram depicting an example of intruder detection in surroundings of a smart home, in accordance with certain embodiments.

Another use case for integrated sensing is object detection for the surroundings of a smart home. As shown in FIG. 4, for example, in outdoor environment 400, intruder detection in surroundings 450 of a smart home is provided. Environment 400 includes WTRU 410 (e.g., which may be the same as WTRU 102a, 102b, 102c, 102d, or 340), intruder (e.g., a bear) 440, and base station 460. WTRU 410 is configured to transmit sensing signal 420, which, in this example, is incident on intruder 440. WTRU 410 is configured to receive reflected signal 430, which, in this example, reflects the sensing signal 420 after incidence with the intruder 440. Base station 460 is configured to transmit sensing signal 470, which, in this example, is incident on surroundings (e.g., the ground) 450. WTRU 410 is configured to receive reflected signal 480, which, in this example, reflects the sensing signal 470 after incidence with surroundings 450.

In the scenarios of FIG. 3 and FIG. 4, a base station (e.g., 350, 360, 460) and/or a WTRU (e.g., 340, 410) can detect the intrusion of an object (e.g., cow 310, vehicle 320, bear 440) into the sensing area of the base station by itself or by collaboration between the WTRU and the base station. For example, the sensing measurement is transferred to the core network 375 and further processed into the sensing result.

In certain embodiments, transparent sensing is another use case for integrated sensing where sensing data is captured by a WTRU and communicated so that 5GS is aware of the sensing information. The WTRU may acquire sensing measurements from different 3GPP and non-3GPP devices. 5GC may determine various available sensing services by processing collated sensing data.

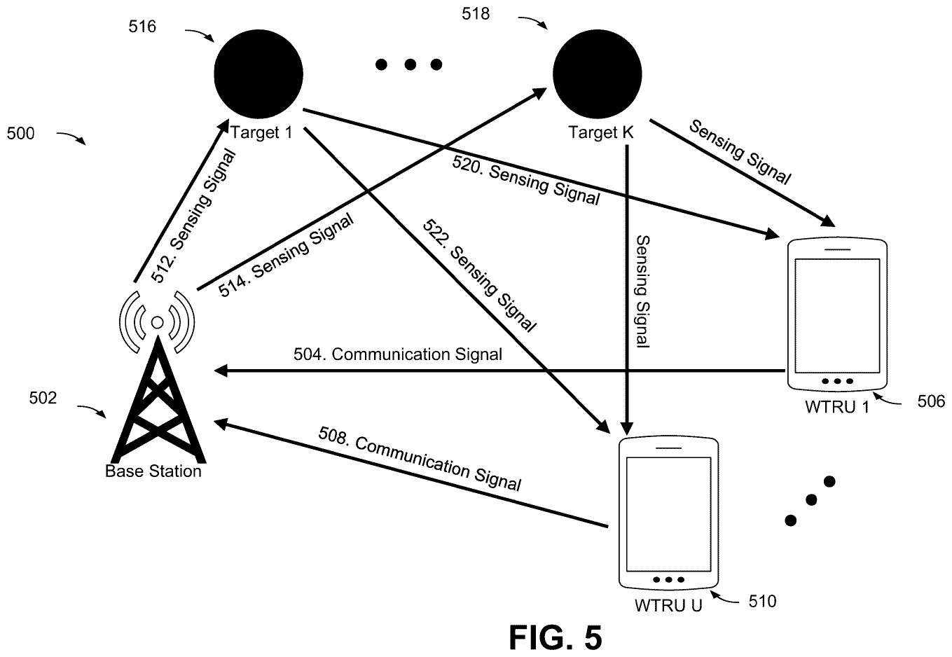

FIG. 5 illustrates an example of bistatic sensing where the sensing signal sender and sensing signal receiver are two different nodes. For example, in an environment 500, a base station 502 (e.g., which may be the same as base station 114a, 114b) may receive a communication signal 504 from WTRU 506 (e.g., which may be the same as WTRU 102a, 102b, 102c, 102d, 340, or 440) and receive a communication signal 508 from WTRU 510 (e.g., which may be the same as WTRU 102a, 102b, 102c, 102d, 340, or 440). The base station 502 may also send first sensing signals 512 and 514 to targets 516 and 518, respectively. A target may reflect a first sensing signal to generate a second sensing signal (e.g., sensing signal 520 or 522) that may be recorded at a WTRU receiving the sensing signal. In FIG. 5, “K” of “Target K” and “U” of “User U” may represent any suitable integers. It will be understood that, e.g., if U equals five, then there would be five respective user devices although only two are shown. It will also be understood that, e.g., if K equals three, there would be three respective targets although only two are shown

Various sensing operation types exist in integrated sensing applications. For example, a sensing operation type may include radar like sensing such that the sensing transmitter and receiver are co-located in the same entity (i.e., monostatic sensing). A sensing operation type may include sensing such that the sensing receiver and sensing transmitter are different entities (i.e., bistatic sensing). In multistatic sensing, multiple sensing transmitters and multiples sensing receivers may exist to perform a particular task.

In certain embodiments, a 5G system may be able to provide 5G wireless sensing service in a target sensing service area location using sensing transmitters and sensing receivers. The 5G network may be able to activate, configure, and deactivate certain wireless sensing tasks based on certain parameters such as location or network conditions.

In some approaches, 3GPP sensing procedures may not enable the discovery, selection, activation, or deactivation of sensing entities with restrictions based on dynamic conditions. A network entity should determine, in addition to existing determination mechanisms, what dynamic conditions may be relevant for a sensing operation. It may be desirable for a network entity to have access to information regarding particular restrictions for certain WTRU roles or dynamic conditions (e.g., WTRU location, time, sensing accuracy, or data recipients). For example, it may be desirable for a network entity to have access to information indicative of how to deactivate a sensing entity when the sensing entity moves into a restricted location and how to reactivate a sensing entity when a device moves out of a restricted area.

It may be desirable to determine sensing restrictions for the sensing entities based on different roles regarding sensing operation (monitoring entity, sending/receiving entity, etc.), sensing location, sensing data collection time, service network, consumer of sensing data, sensing scope, or any suitable combination thereof. It may also be desirable to determine how to dynamically enforce sensing restrictions during sensing operations. Sensing operations may include one or more of sensing entity discovery, selection, configuration, activation, or deactivation; sensing data collection or processing; or releasing sensing results to a party with scope and granularity based on a set of conditions (e.g., who/whom/when/where/how).

Accordingly, systems and methods are described herein for restricting sensing entities during a sensing procedure. The systems and methods may include at least one of the following operations: a WTRU registers with an AF (e.g., a sensing AF); the sensing AF determines inputs for the sensing restrictions; a sensing NF receives sensing restriction parameters, e.g., from a NF, AF (e.g., the sensing AF), application server (AS), or the like; the sensing NF selects the most suitable sensing entities (e.g., WTRUs) and corresponding sensing modes to satisfy requirements of the sensing restrictions (e.g., sensing restriction parameters); the wireless network configures the sensing entities (e.g., WTRUs) for the sensing restrictions (e.g., based on a sensing policy) and initiates a sensing task; the sensing entities (e.g., WTRUs) begin sensing based on receiving sensing task start information; combinations of the same; or the like.

In certain embodiments, a WTRU (e.g., sensing entity) registers with the AF. For example, the WTRU may provide its sensing capabilities and/or user consent information (e.g., including user conditions and/or agreements associated with collection, processing, and/or release of sensing data). Furthermore, for example, the WTRU may be authorized for sensing with restriction conditions.

In certain embodiments, a restriction policy includes restriction conditions based on inputs from the AF, control NF, unified data repository (UDR), operator rules, regional laws and regulation, combinations of the same, or the like. In certain embodiments, the restriction policy is enforced in various stages of a sensing operation. For example, the restriction policy may be enforced in at least one of the following stages: sensing entity discovery, sensing data collection, sensing data processing, sensing result release, combinations of the same, or the like.

In certain embodiments, a sensing AF determines the inputs for the restriction conditions. For example, the inputs may include at least one of the following sensing restrictions: proximity restrictions, sensing accuracy limits, sensing timing restrictions, sensing entity and role whitelists and/or blacklists, sensing data consumer restrictions, combinations of the same, or the like.

In certain embodiments, a sensing NF receives sensing restriction parameters from a NF, AF, AS, or the like. For example, the received sensing restriction parameters may specify particular sensing restriction conditions.

In certain embodiments, the sensing NF communicates with other NFs to obtain information of WTRUs and other sensing entities. For example, the sensing NF may obtain such information from a local stored database, by querying another NF, or by querying the sensing entities. In certain embodiments, the sensing NF receives such information from capability reports transmitted by the sensing entities.

In certain embodiments, the sensing NF formulates a sensing policy with sensing restrictions based on at least one of the following: pre-configured restriction areas, sensing entity whitelists and/or blacklists, regulations, privacy laws, user consent, combinations of the same, or the like. For example, the restriction conditions may be built into the restriction policy and may be formulated with inputs from AF, control NF, UDR, operator's rules, regional laws and regulations, combinations of the same, or the like.

In certain embodiments, the sensing NF selects the most suitable sensing entities and corresponding sensing modes to satisfy the requirements of the sensing restrictions. For example, some devices (e.g., sensing entities, WTRUs) may be included and/or excluded from sensing entity discovery based on at least one of the following: presence on a blacklist and/or whitelist, presence at a restricted location, presence at a restricted time, user consent, combinations of the same, or the like.

In certain embodiments, the wireless network configures (e.g., sensing NF) sensing entities based on sensing restrictions of the sensing policy and initiates a sensing task. For example, the sensing NF may send a configuration along with the restriction policy and initiation messages to the selected sensing entities. Further, for example, the configuration may include any of the restriction parameters to be used in determining restriction conditions and associated actions.

In certain embodiments, the sensing entities (e.g., WTRUs) begin sensing based on receiving sensing task start information. For example, sensing task start information may include the sensing policy. Further, for example, the sensing policy may specify conditions and actions during sensing discovery, sensing data collection, sensing data processing, and/or sensing results releasing. Moreover, for example, the sensing restrictions may be enforced for each sensing entity in the sensing procedure, e.g., during sensing data collecting, sensing data processing, and/or sensing results releasing.

For example, conditions specified by the sensing policy may include at least one of the following parameters: sensing time, sensing location, network that providing sensing service, sensing target device, combinations of the same, or the like. Further, for example, the sensing policy may indicate at least one of: actions that are allowed and/or disallowed, sensing accuracy reduction, image blurring, text removal in video and/or photos, sensing data consumer restrictions, forbidden actions, privacy information anonymization, combinations of the same, or the like.

In accordance with certain embodiments of the present disclosure, sensing restriction parameters are described as follows.

In certain embodiments, the restriction conditions are determined based on inputs from at least one of the AF, control NF, UDR, operator rules, regional laws and regulation, combinations of the same, or the like. In certain embodiments, the sensing restriction policy is determined based on the restriction conditions. For example, the sensing restriction policy may be enforced in various stages of sensing operation (e.g., sensing entity discovery, sensing data collection, sensing data processing, sensing result releasing, or the like).

In certain embodiments, the sensing restriction policy specifies conditions and/or actions to be used for sensing discovery, sensing data collection, sensing data processing, sensing results releasing, or the like. For example, the conditions may include at least one of the following parameters: sensing time, sensing location, network that provides sensing service, sensing target device, combinations of the same, or the like. Further, for example the actions may include at least one of: allowed actions, disallowed actions, accuracy reduction, sensing results release, forbidden actions, anonymization actions, combinations of the same, or the like. Moreover, for example, the sensing restrictions may be applied independently or may combined based on at least one of the following: location codes, sensing operation time, restricted entities/roles, sensing data consumers, privacy in the sensing data, accuracy requirements of sensing data processing, combinations of the same, or the like.

For example, some devices may be included and/or excluded during sensing entity discovery when the sensing entity devices are on the blacklist and/or whitelist. Further, for example, such devices may be included and/or excluded during sensing entity discovery based on the sensing entity being at a restricted location or the sensing being performed at a restricted time. Moreover, for example, devices may be included and/or excluded as data release targets based on privacy restrictions of the target device.

For example, the restrictions may be associated with a sensing entity role. Further, for example, the sensing entity role may be at least one of the following: performed in the sensing operation, in a restricted service network, a restricted consumer of sensing results information, a sensing scope, combinations of the same, or the like. Further, for example, a restricted time may be informed to a sensing entity (e.g., to indicate when not to send the sensing signal). Moreover, for example, discovery of sensing entity may include determining that the sensing transmitter should not transmit the sensing signal to the restricted area and/or the sensing receiver should not receive the sensing signal across the restricted area.

For example, the sensing operation may be associated with fine-grained control. For example, the sensing operation may be associated with an exact one or more devices. Further, for example, the sensing operation may be associated with at least one of the following fine-grained control parameters: a device ID or group of device IDs; a location perimeter within a radius; accuracy of sensing data collected and processed; combinations of the same; or the like.

For example, the target ID may be anonymized based on a privacy restriction (e.g., so that the presence of an object is known at a location without releasing the real ID of the object). Further, for example, after the restriction policy is formulated, the restriction policy may be provisioned to the sensing entities.

For example, privacy information (e.g., privacy regulation and/or user consent) may be used as inputs (e.g., for the restriction conditions) when determining the restriction policy. Further, for example, a general data protection regulation (GDPR) privacy law may forbid the WTRU location data from being released to outside the region where the GDPR restrictions apply.

For example, when the restriction policy is enforced in the sensing process, the sensing data may be privacy protected. Further, for example, the sensing data may be anonymized. Moreover, for example, part of an image (e.g., licensing plate, human face, or the like) may be blurred. Also, for example, the sensing data may be released to restricted entities and/or consumers.

In certain embodiments, sensing-related restriction parameters are used to form the conditions in the sensing restriction policy. For example, such conditions may be included in sensing restrictions for sensing operations (e.g., sensing entity discovery, configuration, activation and deactivation, data collection, data processing, combinations of the same, or the like) and/or provided to the consumer that sensing results are released to. Further, for example, the parameter may be used individually or together with a combination of parameters. Moreover, for example, sensing restriction parameters may include at least one of the following: proximity of the sensing operation; location of interest; network operator (e.g., that should provide for or be limited from the sensing operation); sensing data consumer; sensing time frame; sensing data accuracy; entity and roles; power requirements; mobile network operator; WTRU role restrictions; public or private designation; combinations of the same; or the like.

For example, proximity of the sensing operation may include a location code or a set of global positioning service (GPS) coordinates in the form of an area or trajectory. Further, for example, the proximity may include a set of GPS coordinates that specify an area where sensing activity is forbidden or limited to authorized sensing entities only. Moreover, for example, the proximity may include a cycle specified by a GPS coordinate with a radius, where sensing activity is forbidden or limited to authorized sensing entities only. Additionally, for example, the parameter may be used by the control NF.

For example, the location of interest may include location of the target object or sensing object (e.g., if known). Further, for example, the restriction may include a location code (e.g., a zip code, a building, a city name, or the like). Additionally, for example, the parameter may be used by the control NF.

For example, the sensing data consumer may specify how sensing data and control data are transferred and to whom the data is transferred to. Further, for example, the sensing data consumer may be included in a whitelist and/or blacklist that permits or restricts the consumers of the sensing results. Additionally, for example, the parameter may be used by the control NF.

For example, the time frame may indicate a time period during which the sensing task should be performed. Further, for example, the time frame may include an exact time or time range during which the sensing data is collected. Moreover, for example the time frame may include a duration or an exact time window during the day (e.g., 09:00-10:00). Additionally, for example the time frame may be used by the WTRU.

For example, the accuracy parameter may indicate an accuracy of the sensing data or sensing results. Further, for example, the sensing accuracy may not be larger than a threshold to protect the privacy of the target. Moreover, for example, the sensing data accuracy may be adjusted before releasing the sensing results. Additionally, for example, the parameter may be used by the control NF and/or WTRU.

For example, the entity and roles parameters may specify a sensing entity and its sensing role performed in the sensing operation. Further, for example, one entity may perform the allowed roles. Moreover, for example, the entity and roles parameter may be used to limit the role an entity can perform. Additionally, for example, the entity and roles parameter may be used by the control NF.

For example, the sensing entities may perform sensing (e.g., only) when they have a required amount of battery power or have a battery power above a configured threshold (e.g., especially for the WTRUs that adjust their sensing activities based on the battery power). Further, for example, if the battery power is below a threshold, the sensing activity may be paused or reduced by the WTRU.

For example, the sensing entities may perform sensing (e.g., only) when they are being served by configured mobile networks. Further, for example, the WTRU may perform sensing activities (e.g., only) when the WTRU is served by the configured mobile network. Moreover, for example, the mobile network may be pre-configured or provided to the WTRUs via non access stratum (NAS) signaling.

For example, the sensing entities may perform sensing (e.g., only) when the sensing entities are performing and/or behaving as a configured role. Further, for example, if the WTRU acts as a WTRU-to-network relay as well as a normal WTRU, based on the configuration, the WTRU may not be allowed to be a sensing entity. Moreover, for example, the WTRU may not be allowed to be a sensing entity if the WTRU is behaving as a WTRU-to-network relay.

For example, sensing entities may be designated as public or private. Further, for example, based on their public or private designation, the wireless network and other sensing entities may collect and use sensing data from the sensing entities.

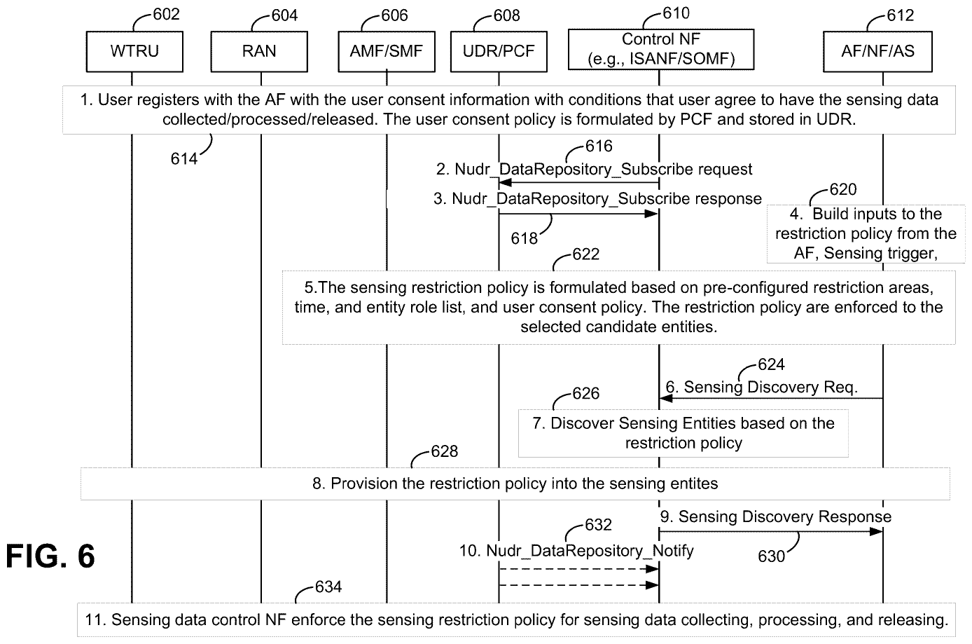

FIG. 6 is a flowchart of an illustrative approach for sensing operation restrictions and enforcement, in accordance with certain embodiments.

At 614, the user registers with AF/NF/AS 612. At 614, WTRU 602 (e.g., which may be any of WTRUs 102a-102d, 340, 410, 506, or 510) may provide its sensing capabilities and/or user consent information with conditions such that the user agrees to have their sensing data collected, processed, and released. WTRU 602 may be authorized for sensing with restrictions (e.g., defining how only certain sensor data may be collected). WTRU 602 may provide a list of sensors and may provide the roles of said sensors (e.g., private, public, trusted, or un-trusted). The sensing restriction conditions may be based on capability parameters previously mentioned above.

In certain embodiments, restriction conditions are factored into a restriction policy that is formulated with inputs from an AF, control NF, UDR, operator rules, regional laws or regulations, (e.g., as noted in 622). The restriction policy may be enforced in various stages of a sensing operation, such as at any of the operations from 624 to 634. For example, the restriction policy may be enforced during sensing entity discovery, data collection, data processing, or result release.

In certain representative embodiments, the operations at 614 may be performed via a variety of ways. For example, the operations at 614 may be performed using WTRU registration procedures or may be performed with an NF or an AF (via the NEF). The operations 614 may also occur through control plane signaling or periodic or event-based reporting.

At 616 and 618, sensing NF 610 subscribes WTRU data from the NFs (e.g., UDR/PCF 608, WTRU context function, tracking and reachability function, AMF/SMF 606) and receives a response with requested data. AMF/SMF 606 may correspond to any of AMFs 182a-182b or SMF 183a-183b, respectively. Any information changes associated with WTRU 602, such as a location change, mobility, availability, or sensing capability changes, may be received. UDR/PCF 608 need not specifically perform the operations of 616 or 618. That is, other network functions may also perform operations occurring at 616 and 618.

At 620, AF/NF/AS 612 builds inputs to the sensing restriction and triggers the sensing procedure. The inputs may include, but are not limited to, any sensing restriction such as a proximity restriction, sensing accuracy limit, restriction on sensing timing, sensing entity role whitelist/blacklist configurations, or the sensing data consumer restriction.

At 622, a sensing task is triggered at AF/NF/AS 612. An illustrative trigger may be an application which requires the generation of a real-time map of a user's environment (e.g., RF environment mapping). The application may require additional information from the network. An NF may determine that sensing data is needed for optimizing network resources (e.g., beam management and mobility enhancements). A message from AF/NF/AS 612 may include requirement parameters specifying the requirements of the request. An NF may communicate with other NFs for obtaining information of WTRUs or other sensing entities.

In certain embodiments, an NF may obtain information from a local stored database, by querying another NF, or by querying other sensing entities. AF/NF/AS 612 may receive such information from a capability report received from a sensing entity.

In certain representative embodiments, an NF may formulate a sensing policy with sensing restrictions based on pre-configured restriction areas, an entity list, regulations, privacy laws, or user consent. The inputs to the restrictions may be from 614-620.

In certain embodiments, restriction conditions are factored into a sensing restriction policy that is formulated with inputs from AF/NF/AS 612, sensing NF 610, UDR/PCF 608, operator rules, regional laws, or regulations. The sensing restriction policy may be enforced in various stages of sensing operation such as sensing entity discovery, sensing data collection, sensing data processing, or sensing result release.

In certain embodiments, a policy specifies the conditions and actions during sensing discovery, sensing data collection, sensing data processing, or sensing result releasing.

In certain embodiments, a policy may specify that, for certain conditions, the sensing entity must get authorization/approval/acceptance from the core network (e.g., via sensing NF 610), each time before sensing/transmitting sensing data.

At 624, sensing NF 610 receives a sensing request from AF/NF/AS 612. This message may be a sensing entity discovery message or a sensing service request.

At 626, sensing NF 610 selects most suitable sensing entities and their sensing modes, e.g., to satisfy the requirements of the sensing restrictions. For example, some devices may be included or excluded during the sensing entity discovery due to the device being on a blacklist or whitelist, at restricted location, at restricted time, allowed/disallowed by user consent, or any suitable combination thereof.

At 628, sensing entities are configured for the sensing restrictions in term of the sensing policy, and the task is initiated. At 628, sensing NF 610 sends configuration and initiation messages to the chosen sensing entities. The configuration may include parameters such as any of those related to proximity, location of interest, network operator, sensing data consumer, time frame, accuracy, entity or roles, power requirements, mobile network operators, WTRU role restrictions, or public or private rules to be used in determining the restriction condition and associated actions.

At 628, sensing entities may receive an indication on when to start the sensing task. This may be specified as a timer value. Sensing entities may acknowledge successful or failure of updated policy configuration. In case of failure of an updated policy configuration, sensing entities may provide specific cause value to indicate reason of failure (e.g., the WTRU power status has changed or WTRU is no longer available to participate in sensing).

At 628, sensing NF 610 may specify if further configuration may be required. For example, it may be required for the sensing entities to communicate with each other for calibrating its parameters. (e.g., parameters used in the conditions in the restriction policy or initialization parameters related to connectivity to be established for sharing sensing data or results). For example, this may be done by provision of a policy to the sensing entities, and the sensing entity may carry out sensing “independently.”

At 630, sensing NF 610 responds to the discovery request at 624 with sensing entities that meet the sensing restrictions.

At 632, sensing NF 610 receives the WTRU data notification from UDR/PCF 608 with requested data.

At 634, sensing entities start sensing based on the sensing task information received. Policies may specify the conditions and actions during sensing discovery and data collection, sensing data processing, and sensing result releasing. Sensing restrictions are enforced at each sensing entity in the sensing procedures such as sensing data collecting, sensing data processing, and sensing result releasing. Conditions may include parameters such as sensing time, location, network, or target device information. Actions may include allowing, disallowing, accuracy reducing, image blurring, text removing (e.g., in video or photos), sensing data consumer restricting, forbidding, or privacy information anonymizing. For example, the target identification may be anonymized due to restriction of the privacy so that only an object is known at a location without releasing the real identification of the object. After the restriction policy is formulated, it can be provisioned into the sensing entities. Some devices may be included or excluded as the data release targets due to privacy restriction of the target device.

In certain representative embodiments, restrictions may be based on the location of a sensing event, sensing data collection time, a service network, sensing result consumer information, sensing scope, or any suitable combination thereof. For example, a sensing entity may be informed of a restricted time to not to send a sensing signal. In another example, a sensing entity may be informed of a restricted area such that the sensing entity may not transmit a sensing signal to the restricted area and a sensing receiver not to receive sensing signal across the restricted area.

In certain embodiments, restrictions may correspond to an exact device with a particular device ID, group of IDs, a location point within a particular accuracy, or an accuracy of sensing data collected and processed, or any suitable combination thereof.

In certain embodiments, when a restriction policy is enforced in the sensing process, sensing data may be privatized or protected. For example, sensing data may be anonymized, part of an image may be blurred (e.g., a license plate or human face may be blurred), or released to restricted entities. Privacy information may be used as inputs when the restriction policy is considered. For example, a GDPR privacy law may forbid WTRU location data from being released to outside of the region where the GDPR restricts.

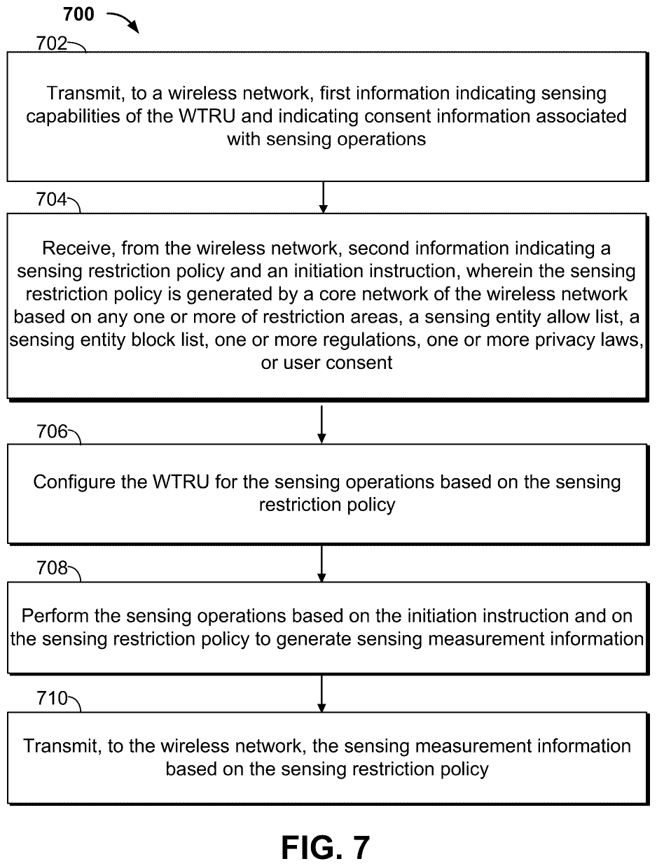

FIG. 7 is a flowchart of an illustrative method performed by a WTRU for sensing operation restrictions and enforcement, in accordance with certain embodiments.

In certain representative embodiments, as shown in FIG. 7, a process 700 is performed by a WTRU (e.g., WTRU 102 of FIGS. 1A-D, WTRU 208 of FIG. 2, WTRU 340 of FIG. 3, WTRU 410 of FIG. 4, WTRUs 506 and 510 of FIG. 5, WTRU 602 of FIG. 6) in connection with a wireless network (e.g., including core network 106 and 115 of FIGS. 1A-D, core network 375 of FIG. 3, RAN 104 and 113 of FIGS. 1A-D, RAN 604 and network entities 606-612 of FIG. 6), which may be implemented in communications system 100 illustrated in FIG. 1A-1D.

At 702, the WTRU transmits, to a wireless network, first information. For example, the first information may indicate sensing capabilities of the WTRU. Further, for example, the WTRU may indicate consent information associated with sensing operations. In certain embodiments, the first information indicates a plurality of sensing entities and a sensing role for each of the plurality of sensing entities. For example, the sensing role may include at least one of: monitoring entity, sending entity, target entity, combinations of the same, or the like. In certain embodiments, the WTRU transmits the first information by at least one of: a WTRU registration procedure; NF, AF, or NEF signaling; control plane signaling; periodic-based reporting; event-based reporting; combinations of the same; or the like.

At 702, the WTRU receives, from the wireless network, second information. For example, the second information may indicate a sensing restriction policy. Further, for example, the second information may indicate initiation instruction. In certain embodiments, the sensing restriction policy is generated by a core network of the wireless network based on at least one of: restriction areas, a sensing entity allow list, a sensing entity block list, one or more regulations, one or more privacy laws, user consent; combinations of the same; or the like. In certain embodiments, the core network generates the sensing restriction policy further based on at least one of the following parameters: proximity of the sensing operations; a location of interest; a network operator identity; a sensing data consumer; a time frame; an accuracy; sensing entities and corresponding roles; power requirements; a mobile network operator; a WTRU role; a public or private designation; combinations of the same; or the like. In certain embodiments, the sensing restriction policy includes at least one of the following restrictions: sensing location restrictions; sensing collection time restrictions; service network restrictions; sensing information consumer restrictions; scope restrictions; combinations of the same; or the like. In certain embodiments, the sensing restriction policy includes at least one of the following conditions: allowed actions; disallowed actions; accuracy reduction; image blurring; text removal; sensing data consumer restrictions; privacy information anonymization; combinations of the same; or the like. In certain embodiments, the sensing restriction policy indicates that the WTRU must request authorization from the core network before performing and/or transmitting each of the sensing operations. In certain embodiments, the initiation instruction includes a timer value indicating when to start performing the sensing operation.

At 704, the WTRU configures (e.g., the WTRU) for the sensing operations based on the sensing restriction policy.

At 706, the WTRU performs the sensing operations to generate sensing measurement information. In certain embodiments, the WTRU performs the sensing operations based on the initiation instruction and on the sensing restriction policy. In certain embodiments, the sensing measurement information includes an indication of whether the sensing restriction policy was successfully implemented. In certain embodiments, the WTRU performs the sensing operations by enforcing the sensing restriction policy during at least one of: sensing entity discovery, data collection, data processing, sensing result release, combinations of the same, or the like.

At 708, the WTRU transmits, to the wireless network, the sensing measurement information based on the sensing restriction policy.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), the method comprising:
transmitting, to a wireless network, first information indicating sensing capabilities of the WTRU and indicating consent information associated with sensing operations;
receiving, from the wireless network, second information indicating a sensing restriction policy and an initiation instruction, wherein the sensing restriction policy is generated by a core network of the wireless network based on any one or more of restriction areas, a sensing entity allow list, a sensing entity block list, one or more regulations, one or more privacy laws, or user consent;
configuring the WTRU for the sensing operations based on the sensing restriction policy;
performing the sensing operations based on the initiation instruction and on the sensing restriction policy to generate sensing measurement information; and
transmitting, to the wireless network, the sensing measurement information based on the sensing restriction policy.

2. The method of claim 1, wherein the first information indicates a plurality of sensing entities and a sensing role for each of the plurality of sensing entities, wherein the sensing role comprises any one of a monitoring entity, a sending entity, or a target entity.

3. The method of claim 1, wherein transmitting the first information comprises any one of:
a WTRU registration procedure;
network function (NF) signaling, application function (AF) signaling, or network exposure function (NEF) signaling;
control plane signaling;
periodic-based reporting; or
event-based reporting.

4. The method of claim 1, wherein the core network generates the sensing restriction policy further based on any of the following parameters:
proximity of the sensing operations;
a location of interest;
a network operator identity;
a sensing data consumer;
a time frame;
an accuracy;
sensing entities and corresponding roles;
power requirements;
a mobile network operator;
a WTRU role; or
a public or private designation.

5. The method of claim 1, wherein the sensing restriction policy comprises any of the following restrictions:
sensing location restrictions;
sensing collection time restrictions;
service network restrictions;
sensing information consumer restrictions; or
scope restrictions.

6. The method of claim 1, wherein the sensing restriction policy comprises any of the following conditions:
allowed actions;
disallowed actions;
accuracy reduction;
image blurring;
text removal;
sensing data consumer restrictions; or
privacy information anonymization.

7. The method of claim 1, wherein the sensing restriction policy indicates that the WTRU must request authorization from the core network before performing or transmitting each of the sensing operations.

8. The method of claim 1, wherein the initiation instruction comprises a timer value indicating when to start performing the sensing operations.

9. The method of claim 1, wherein the sensing measurement information comprises an indication of whether the sensing restriction policy was successfully implemented.

10. The method of claim 1, wherein performing the sensing operations based on the sensing restriction policy comprises enforcing the sensing restriction policy during at least one of: sensing entity discovery, data collection, data processing, or sensing result release.

11. A wireless transmit/receive unit (WTRU) comprising:
a processor; and
a transceiver coupled to the processor, wherein the WTRU is configured to:
transmit, to a wireless network, first information indicating sensing capabilities of the WTRU and indicating consent information associated with sensing operations;
receive, from the wireless network, second information indicating a sensing restriction policy and an initiation instruction, wherein the sensing restriction policy is generated by a core network of the wireless network based on any one or more of restriction areas, a sensing entity allow list, a sensing entity block list, one or more regulations, one or more privacy laws, or user consent;
configure the WTRU for the sensing operations based on the sensing restriction policy;
perform the sensing operations based on the initiation instruction and on the sensing restriction policy to generate sensing measurement information; and
transmit, to the wireless network, the sensing measurement information based on the sensing restriction policy.

12. The WTRU of claim 11, wherein the first information indicates a plurality of sensing entities and a sensing role for each of the plurality of sensing entities, wherein the sensing role comprises any one of a monitoring entity, a sending entity, or a target entity.

13. The WTRU of claim 11, wherein the WTRU is configured to transmit the first information by any one of:
a WTRU registration procedure;
network function (NF) signaling, application function (AF) signaling, or network exposure function (NEF) signaling;
control plane signaling;
periodic-based reporting; or
event-based reporting.

14. The WTRU of claim 11, wherein the core network generates the sensing restriction policy further based on any of the following parameters:
proximity of the sensing operations;
a location of interest;
a network operator identity;
a sensing data consumer;
a time frame;
an accuracy;
sensing entities and corresponding roles;
power requirements;
a mobile network operator;
a WTRU role; or
a public or private designation.

15. The WTRU of claim 11, wherein the sensing restriction policy comprises any of the following restrictions:
sensing location restrictions;
sensing collection time restrictions;
service network restrictions;
sensing information consumer restrictions; or
scope restrictions.

16. The WTRU of claim 11, wherein the sensing restriction policy comprises any of the following conditions:
allowed actions;
disallowed actions;
accuracy reduction;
image blurring;
text removal;
sensing data consumer restrictions; or
privacy information anonymization.

17. The WTRU of claim 11, wherein the sensing restriction policy indicates that the WTRU must request authorization from the core network before performing or transmitting each of the sensing operations.

18. The WTRU of claim 11, wherein the initiation instruction comprises a timer value indicating when to start performing the sensing operations.

19. The WTRU of claim 11, wherein the sensing measurement information comprises an indication of whether the sensing restriction policy was successfully implemented.

20. The WTRU of claim 11, wherein the WTRU is configured to perform the sensing operations based on the sensing restriction policy by enforcing the sensing restriction policy during at least one of: sensing entity discovery, data collection, data processing, or sensing result release.
